(19) United States
(12) Patent Application Publication
(10) Pub. No.: US 2020/0301061 A1
(43) Pub. Date: Sep. 24, 2020

(54) LOCALLY DIMMABLE LIGHT GUIDE PLATES AND DISPLAY DEVICES COMPRISING THE SAME

(71) Applicant: CORNING INCORPORATED, Corning, NY (US)

(72) Inventors: Jacques GOLLIER, Bellevue, WA (US); Steven S ROSENBLUM, Ithaca, NY (US); Kristopher Allen WIELAND, Painted Post, NY (US); Ying ZHANG, Horseheads, NY (US)

(21) Appl. No.: 16/088,172

(22) PCT Filed: Mar. 28, 2017
(86) PCT No.: PCT/US2017/024432

§ 371 Date: Sep. 25, 2018

Related U.S. Application Data
(60) Provisional application No. 62/316,011, filed on Mar. 31, 2016.

(51) Int. Cl. F21V 8/00; G02B 26/00

(52) U.S. Cl. CPC G02B 6/0035; G02B 26/005; G02B 6/0068

(57) ABSTRACT

Disclosed herein are backlight units comprising a light guide assembly including (110) a light guide plate (105) and least one light valve layer (115), and at least one light source (125) optically coupled to the light guide plate (105), wherein regions of the light guide assembly (110) are configured to switch between active and inactive states, wherein an active region transmits at least about 90% of incident light and an inactive region transmits less than about 10% of incident light. Display devices comprising such backlight units are further disclosed as well as methods for displaying an image.

### CROSS-REFERENCE TO RELATED APPLICATIONS

This application claims the benefit of priority under 35 U.S.C. § 119 of U.S. Provisional Application Ser. No. 62/316011 filed on Mar. 31, 2016, the content of which is relied upon and incorporated herein by reference in its entirety.

### FIELD OF THE DISCLOSURE

The disclosure relates generally to light guide plates and display devices comprising such light guide plates, and more particularly to locally dimmable edge-lit light guide plates and devices.

### BACKGROUND

Liquid crystal displays (LCDs) are commonly used in various electronics, such as cell phones, laptops, electronic tablets, televisions, and computer monitors. However, LCDs can be limited as compared to other display technologies in terms of brightness, contrast ratio, efficiency, and/or viewing angle. For instance, to compete with other display technologies, there is a continuing demand for higher contrast ratio, color gamut, and/or brightness in conventional LCDs while also balancing power requirements and device size (e.g., thickness).

LCDs can comprise a backlight unit (BLU) for producing light that can then be converted, filtered, and/or polarized to produce a desired image. BLUs may be edge-lit, e.g., comprising at least one light source coupled to an edge of a light guide plate (LGP), or back-lit, e.g., comprising a two-dimensional array of light sources disposed behind the LCD panel. Direct-lit BLUs may have the advantage of improved contrast as compared to edge-lit BLUs. For example, to produce dark regions of an image, various light sources in the direct-lit BLU can be turned off to provide local dimming. However, to achieve desired light uniformity and/or to avoid hot spots in direct-lit BLUs, the light source may be positioned at a distance from the LGP, thus making the overall display thickness greater than that of an edge-lit BLU.

Accordingly, it would be advantageous to provide BLUs for display devices that address one or more of the above drawbacks, e.g., to provide thinner BLUs with improved contrast ratio. It would also be advantageous to provide BLUs for display devices having a reduced thickness similar to that of edge-lit BLUs while also providing local dimming capabilities similar to that of back-lit BLUs.

### SUMMARY

The disclosure relates, in various embodiments, to backlight units comprising a light guide assembly comprising a light guide plate and at least one light valve layer; and at least one light source optically coupled to the light guide plate and configured to inject light into the light guide plate, wherein the light guide assembly further comprises a first region and a second region, the first region switchable between an active state and an inactive state. In some embodiments, in an active state, a light-emitting surface of the first region transmits at least about 90% of injected light incident on a corresponding rear panel-facing surface of the first region, and an inactive state, the light-emitting surface of the first region transmits less than about 10% of injected light incident on the corresponding rear panel-facing surface of the first region. In other embodiments, in an active state, at least about 90% of injected light incident on a light-emitting surface is transmitted by the first region, and in an inactive state, less than about 10% of injected light incident on the light-emitting surface is transmitted by the first region. Display and illuminating devices comprising such backlight units are also disclosed herein, as well as methods for displaying an image.

In certain embodiments, the light source may be coupled to one or more edges of the LGP. According to other embodiments, the second region of the light guide assembly can switch between an active and inactive state. The LGP may comprise a plurality of tiles arranged in a two-dimensional array, one or more of such tiles corresponding to a first or second region of the LGP. The light valve layer may be in contact with or adjacent to either a light-emitting surface or a rear panel-facing surface of the LGP.

In various embodiments, the BLU may further comprise a switch mechanism configured to switch the first and/or second regions between active and inactive states. The switching time period can range, for example, from about 10 milliseconds (ms) to about 10 seconds (s). The switch mechanism can induce contact between the LGP and at least a portion of a light valve layer adjacent the LGP or it can change a physical property of at least a portion of a light valve layer in contact with the LGP. According to certain embodiments, a light valve layer adjacent the LGP may comprise a diffusing or light-scattering material. In other embodiments, at least a portion of a light valve layer in contact with the LGP can be induced to change polarization, refractive index, and/or textural properties.

The disclosure also relates to methods for displaying an image, the methods comprising optically coupling a plurality of light sources to at least one edge of a light guide plate comprising a reverse prism film on a light-emitting surface, and modulating the pulse width of at least two light sources in the plurality of light sources to produce a first display region with a first light transmission greater than a second light transmission of a second display region. According to some embodiments, the plurality of light sources may be optically coupled to one edge of the LGP. A first light source in the plurality of light sources may have a different pulse width than that of a second light source in the plurality of light sources. In other embodiments, a first plurality of light sources may be coupled to one edge of the LGP and a second plurality of light sources may be coupled to an adjacent edge of the LGP. A first light source in the first plurality of light sources may have a first pulse width different from a second light source in the second plurality of light sources.

Additional features and advantages of the disclosure will be set forth in the detailed description which follows, and in part will be readily apparent to those skilled in the art from that description or recognized by practicing the methods as described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the disclosure.

### BRIEF DESCRIPTION OF THE DRAWINGS

The following detailed description can be further understood when read in conjunction with the following drawings wherein, when possible, like numerals are used to refer to like elements.

FIGS. 1A-B illustrate a first exemplary backlight unit in active and inactive states according to some embodiments of the disclosure;

FIGS. 2A-B illustrate a second exemplary backlight unit in active and inactive states according to other embodiments of the disclosure;

FIGS. 3A-B illustrate a third exemplary backlight unit in active and inactive states according to various embodiments of the disclosure;

FIGS. 4A-B illustrate a fourth exemplary backlight unit in active and inactive states according to further embodiments of the disclosure;

FIGS. 5A-B illustrate a fifth exemplary backlight unit in active and inactive states according to still further embodiments of the disclosure;

FIGS. 6A-B illustrate light sources with varying pulse widths;

FIG. 7 illustrates a light guide plate comprising a reverse prism film according to certain embodiments of the disclosure; and

FIG. 8 illustrates a two-dimensional array of light sources with varying pulse widths according to various embodiments of the disclosure.

### DETAILED DESCRIPTION

### Backlight Units

Disclosed herein are backlight units comprising a light guide assembly comprising a light guide plate and at least one light valve layer; and at least one light source optically coupled to the light guide plate and configured to inject light into the light guide plate, wherein the light guide assembly further comprises a first region and a second region, the first region switchable between an active state and an inactive state. In some embodiments, in an active state, a light-emitting surface of the first region transmits at least about 90% of injected light incident on a corresponding rear panel-facing surface of the first region, and an inactive state, the light-emitting surface of the first region transmits less than about 10% of injected light incident on the corresponding rear panel-facing surface of the first region. In other embodiments, in an active state, at least about 90% of light incident on a light-emitting surface is transmitted by the first region, and in an inactive state, less than about 10% of light incident on the light-emitting surface is transmitted by the first region. Various devices comprising such backlight units are also disclosed herein, such as display and illuminating devices, e.g., televisions, computers, phones, tablets, and other display panels, luminaires, solid-state lighting, billboards, and other architectural elements, to name a few.

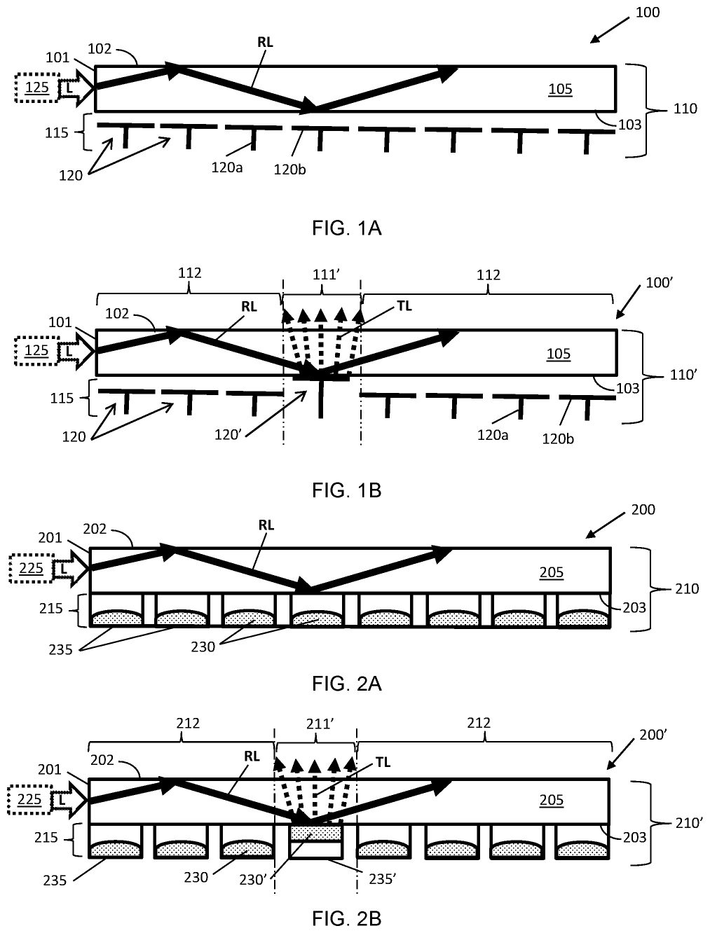

FIGS. 1A-B illustrate one exemplary embodiment of a backlight unit (BLU) in inactive (100) and active (100′) states, respectively. A light guide assembly 110 can comprise a light guide plate (LGP) 105 and a light valve layer 115 adjacent to a surface of the LGP 105. A light source 125, e.g., at least one light-emitting diode (LED), can be optically coupled to the LGP 105 to introduce or inject light L into the LGP.

As used herein, the term “optically coupled” is intended to denote that a light source is positioned relative to the LGP so as to introduce or inject light into the LGP. A light source may be optically coupled to a LGP even though it is not in physical contact with the LGP. As shown in FIG. 1A, the BLU may be edge-lit, e.g., with a light source 225 positioned adjacent to or abutting an edge 101 of the LGP 105. Of course, any light source arrangement is possible, including back-lit BLU arrangements, as appropriate to achieve a desired light output effect. When light is injected into the LGP, according to certain embodiments, the light may propagate as reflected light RL within the LGP due to total internal reflection (TIR).

Total internal reflection (TIR) is the phenomenon by which light propagating in a first material (e.g., glass, plastic, etc.) comprising a first refractive index can be totally reflected at the interface with a second material (e.g., air, etc.) comprising a second refractive index lower than the first refractive index. TIR can be explained using Snell's law:

n₁ sin(θ₁)=n₂ sin(θ₂)

which describes the refraction of light at an interface between two materials of differing indices of refraction. In accordance with Snell's law, n₁ is the refractive index of a first material, n₂ is the refractive index of a second material, Θ₁ is the angle of the light incident at the interface relative to a normal to the interface (incident angle), and Θ₂ is the angle of refraction of the refracted light relative to the normal. When the angle of refraction (Θ₂) is 90°, e.g., sin(Θ₂)=1, Snell's law can be expressed as:

$${θ}_{c} = {θ}_{1} = {sin}^{- 1} ( \frac{{n}_{2}}{{n}_{1}} )$$

The incident angle Θ₁ under these conditions may also be referred to as the critical angle Θ_{c}. Light having an incident angle greater than the critical angle (Θ₁>Θ_{c}) will be totally internally reflected within the first material, whereas light with an incident angle equal to or less than the critical angle (Θ₁≤Θ_{c}) will be transmitted by the first material. In the case of an exemplary interface between air (n₁=1) and glass (n₂=1.5), the critical angle (Θ_{c}) can be calculated as 41°. Thus, if light propagating in the glass strikes the air-glass interface at an incident angle greater than 41°, all the incident light will be reflected from the interface at an angle equal to the incident angle. If the reflected light encounters a second interface comprising an identical refractive index relationship as the first interface, the light incident on the second interface will again be reflected at a reflection angle equal to the incident angle. Accordingly, if, for example, the glass is a glass plate comprising two opposing parallel surfaces defining two opposing air-glass interfaces, light injected into the glass plate can propagate through the glass plate, reflecting alternately between the first and second parallel interfaces unless or until there is a change to the interfacial conditions.

Referring again to FIG. 1A, the LGP 105 can have a light-emitting surface 102 and a rear panel-facing surface 103. As used herein, “light-emitting surface” is intended to denote a major surface of the LGP (or light guide assembly or BLU) facing an intended user, e.g., a major surface emitting light towards a user. Similarly, a “rear panel-facing surface” is intended to denote the opposite major surface of the LGP (or light guide assembly or BLU) that faces away from the user, e.g., towards a rear panel of a device, if present.

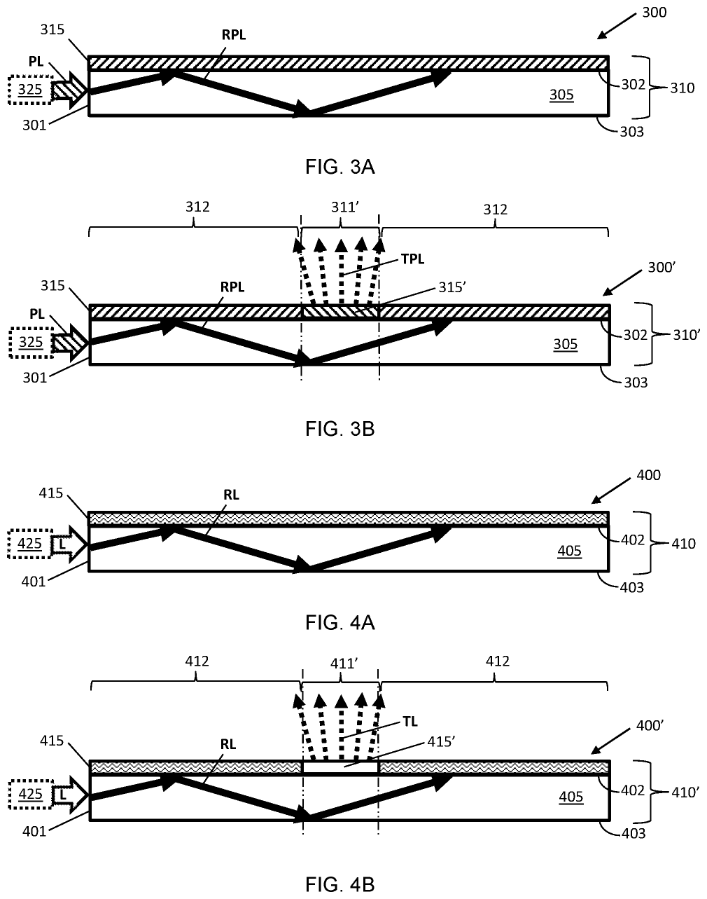

The light valve layer can be positioned adjacent to or in contact with either of the light-emitting surface 102 (e.g., as illustrated in FIG. 3A) or the rear panel-facing surface 103 (e.g., as illustrated in FIG. 1A). According to various embodiments, a light valve layer may be spaced apart from either of surfaces 102 or 103, but may be induced to contact said surfaces by one or more mechanisms, discussed in more detail below. Alternatively, a light valve layer may be in contact with either of surfaces 102 or 103, and can be induced to change its configuration by one or more mechanisms, discussed in more detail below. In some embodiments, a light valve layer in contact with a light-emitting surface 102 may be induced to change configuration, whereas a light valve layer adjacent a rear panel-facing surface 103 may be induced to contact the surface. As used herein, the term “contact” is intended to denote direct physical contact between two or more listed components, e.g., without intervening layers or components, unless indicated otherwise.

FIGS. 1-5 will now be discussed in more detail with respect to “active” and “inactive” states. For purposes of clarity and discussion, activated components and/or units are denoted in the appended Figures with a (') symbol. As used herein, the term “active” is intended to denote a configuration in which at least one portion or component of the light valve layer is altered or switched “on” so as to affect TIR within the LGP. For example, in various embodiments the light valve layer may include a light scattering material, that, when brought into contact with the LGP, disrupts TIR in the region of the LGP contacted by the light valve layer and the incident light undergoes forward scattering in a direction toward the light emitting surface, thereby increasing the amount of light transmitted by the light emitting surface corresponding to the contacted region of the rear panel-facing surface. Thus, for an active portion of a light guide assembly comprising a light valve layer in an active state, transmission of injected light incident upon a light-emitting surface or a rear panel-facing surface of a corresponding region of the LGP may be about 90% or greater, such as greater than about 91%, 92%, 93%, 94%, 95%, 96%, 97%, 98%, or 99%, including all ranges and subranges therebetween, e.g., ranging from about 90-100% transmission.

The term “inactive” is intended to denote a configuration in which at least one portion or component of the light valve layer does not or does not substantially impact TIR within the LGP. Thus, for an inactive portion of a light guide assembly comprising a light valve layer in an inactive state, transmission of injected light incident upon a light-emitting surface or a rear panel-facing surface of a corresponding region of the LGP may be less than about 10%, such as less than about 9%, 8%, 7%, 6%, 5%, 4%, 3%, 2%, 1%, including all ranges and subranges therebetween, e.g., ranging from about 0-10% transmission.

Respective portion(s) of the light valve layer may be switched “on” (active) and “off” (inactive) as appropriate to produce the desired light output. As such, one or more portions of the light valve layer may serve as “valves” that optically and/or physically interact with the LGP and can be opened or closed to affect the light output for specific desired region(s) of the light guide assembly. The operation of such valves can be based, in certain embodiments, on the principle of TIR within the LGP, as discussed in more detail herein.

FIG. 1A illustrates an exemplary BLU 100 in an inactive state. For example, the light valve layer 115 adjacent the rear panel-facing surface 103 is spaced apart from the surface and, thus, may not impact TIR within the LGP 105. FIG. 1B illustrates a BLU 100′ in which at least a first region 111′ of the light guide assembly 110′ is an active state. In the illustrated embodiment, the light valve layer 115 comprises moving part(s) 120, one of which has been activated (120′) or switched “on.” The moving part(s) 120 may, in some embodiments, comprise all or part of an electromechanical system, e.g., a micro-electro-mechanical system (MEMS), which may be controlled by a switch mechanism such as a control unit (not shown). The moving part(s) 120 can comprise a mechanical element 120a and an optical element 120b, such as a diffusing or scattering material. Exemplary diffusing or scattering materials can include, for example, polymer resins containing silica, titania, polymethyl-methacrylate spheres, and the like.

Upon receipt of an electrical signal, the mechanical element 120a of the moving part(s) 120 can be activated to induce direct physical contact between the optical element 120b and the rear panel-facing surface 103 of the LGP 105. In this active state, as demonstrated by activated moving part 120′, TIR may be reduced (e.g., TIR<10%) for injected light incident upon the rear panel-facing surface 103 of first region 111′, such that light RL propagating through the LGP is scattered forward from the rear panel-facing surface 103 at moving part(s) 120′ and is transmitted through the corresponding region of the light-emitting surface 102 as transmitted light TL, e.g., because the forward-scattered light is at an angle less than or equal to the critical angle for the light-emitting surface. For instance, about 90% or greater of the forward scattered light may have an incident angle (Θ₁) less than the critical angle (Θ_{c}). In contrast, portions of the rear panel-facing surface 103 in second regions 112, which do not comprise an activated component in contact therewith, will not exhibit reduced TIR (e.g., TIR>90%) and the corresponding regions of the light-emitting surface 102 will not, or will not substantially, transmit light. Accordingly, in some embodiments, when viewed by a user, a portion of a display corresponding to first region(s) 111′ may appear illuminated whereas a portion of the display corresponding to the second region(s) 112 may appear dark.

While FIGS. 1A-B are illustrated with gaps between moving parts 120, it is to be understood that this illustration is solely for purposes of explaining aspects of the disclosure and, in practice, these gaps may not be present. Moreover, while FIG. 1B illustrates only one activated moving part 120′, it is to be understood that any number of moving parts 120 may be activated as appropriate to produce a desired light output. Furthermore, it is also possible for moving parts 120 to be separately controllable, e.g., a first region (e.g., 111′) may have active/inactive moving parts and a second region (e.g., 112) may have active/inactive moving parts. Finally, it is to be understood that the illustrated embodiment in FIGS. 1A-B is exemplary only and is not intended to be limiting on the appended claims. Any suitable arrangement for inducing contact between the optical component and LGP surface may be used and is intended to fall within the scope of the disclosure.

FIGS. 2A-B illustrate another exemplary embodiment of a BLU in inactive (200) and active (200′) states, respectively. Similar to FIGS. 1A-B, a light guide assembly 210 can comprise an LGP 205 and a light valve layer 215 adjacent to a surface of the LGP 205. A light source 225 can be optically coupled to the LGP 205 to introduce light L to the LGP, e.g., to at least one edge 201 of the LGP 205. As illustrated, the light valve layer 215 can comprise one or more frames or cavities 235, which may contain a charged material 230. The charged material 230 can be in any physical state, such as a solid or liquid, and can carry a positive or negative charge, or, in some embodiments, a mixture of positively and negatively charged materials can be used. Non-limiting examples of suitable charged materials 230 may include, for instance, pigments, polystyrene beads, polyelectrolytes, electromagnetic materials, and like materials.

Similar to FIG. 1A, in an inactive state (as depicted in FIG. 2A), a charged material 230 in the light valve layer 215 adjacent the rear panel-facing surface 203 is spaced apart from the surface and, thus, may not impact TIR within the LGP 205. It is noted that, in the inactive state, a portion of layer 215 may be in contact with surface 203 (e.g., the sidewalls of cavities 235), while other portions of layer 215 may be spaced-apart from the surface 203 (e.g., material 230 in the cavities). FIG. 2B illustrates a BLU 200′ in which at least a first region 211′ of the light guide assembly 210′ is an active state. In the illustrated embodiment, charged material 230′ in a selected cavity 235′ has been activated or switched “on” by attracting that material to the surface 203 of the LGP 205.

Upon application of an electric field, e.g., by a switch mechanism comprising one or more positive or negative electrodes (not shown), the charged material 230 in one or more cavities 235 can be activated to induce direct physical contact between the charged material 230 and the rear panel-facing surface 203 of the LGP 205. In this active state, as demonstrated by activated material 230′, TIR may be reduced (e.g., TIR<10%) for injected light incident upon the rear panel-facing surface 203 of first region 211′, such that light RL propagating through the LGP is scattered forward from the rear panel-facing surface 203 at moving part(s) 220′ and is transmitted through the corresponding region of the light-emitting surface 202 as transmitted light TL, e.g., because the forward-scattered light is at an angle less than or equal to the critical angle for the light-emitting surface. For instance, about 90% or greater of the forward scattered light may have an incident angle (Θ₁) less than the critical angle (Θ_{c}). In contrast, portions of the rear panel-facing surface 203 in second regions 212, which do not comprise an activated component in contact therewith, will not exhibit reduced TIR (e.g., TIR>90%) and the corresponding regions of the light-emitting surface 202 will not, or will not substantially, transmit light. Accordingly, in some embodiments, when viewed by a user, a portion of a display corresponding to first region(s) 211′ may appear illuminated whereas a portion of the display corresponding to the second region(s) 212 may appear dark.

Again, while FIGS. 2A-B are illustrated with cavities 235 evenly spaced apart by gaps, it is to be understood that this illustration is solely for purposes of explaining aspects of the disclosure and, in practice, the cavities may have a different spacing in terms of size and/or distribution, and/or the gaps may not be present. Moreover, while FIG. 2B illustrates only one cavity 235′ containing an activated material 230′, it is to be understood that the material in any number of cavities may be activated as appropriate to produce a desired light output. Furthermore, it is also possible for the charged materials 230 to be separately controllable, e.g., a first region (e.g., 211′) may have active/inactive charged materials and a second region (e.g., 212) may have active/inactive charged materials. Still further, each cavity 235 may comprise more than one charged material, e.g., a positively charged material and a negatively charged material, either one of which can be induced to contact surface 203 as desired by applying the appropriate electric field. Finally, it is to be understood that the illustrated embodiment in FIGS. 2A-B is exemplary only and is not intended to be limiting on the appended claims. Any suitable arrangement for inducing contact between the charged material and the LGP surface may be used and is intended to fall within the scope of the disclosure. For example, the layer 215 may comprise discrete frames containing one or more charged materials 230, rather than a monolithic layer comprising cavities as depicted.

FIGS. 3A-B illustrate another exemplary embodiment of a BLU in inactive (300) and active (300′) states, respectively. Similar to FIGS. 1A-B, a light guide assembly 310 can comprise an LGP 305 and a light valve layer 315 in physical contact with a surface of the LGP 305. A light source 325 can be optically coupled to the LGP 305 to introduce polarized light PL to the LGP, e.g., to at least one edge 301 of the LGP 305. As illustrated, the light valve layer 315 can comprise a film having a first polarization (“A”) in contact with a light-emitting surface 302 of the LGP 305. As used herein, “polarization” as it relates to a film pertains to the polarization angle of light that is allowed to pass through the film. The polarization A of valve layer 315 may, in some embodiments, be different than a second polarization (“B”) of the polarized light PL. Non-limiting examples of suitable materials for the film may include, for instance, liquid crystals and other similar materials.

Upon application of an electronic signal or electric field, e.g., by a switch mechanism (not shown), at least a portion of the light valve layer 315 can be activated to change the polarization of a portion of the film, e.g., from A to B. In this active state, as demonstrated by activated portion 315′, polarized light RPL injected into and propagating through the LGP may be transmitted by the light-emitting surface 302 of the first region 311′ as transmitted polarized light TPL. In contrast, the light-emitting surface 302 of second regions 312, which are not activated, will not, or will not substantially, transmit light. Accordingly, in some embodiments, when viewed by a user, a portion of a display corresponding to first region(s) 311′ may appear illuminated whereas a portion of the display corresponding to the second region(s) 312 may appear dark.

While FIG. 3B illustrates only one activated portion 315′, it is to be understood that more than one portion of the light valve layer 315 may be activated as appropriate to produce a desired light output. Furthermore, it is also possible for the activated portion(s) 315′ to be separately controllable, e.g., a first region (e.g., 311′) may have active/inactive light valve portions and a second region (e.g., 312) may have active/inactive light valve portions. Finally, it is to be understood that the illustrated embodiment in FIGS. 3A-B is exemplary only and is not intended to be limiting on the appended claims. Any suitable arrangement for altering one or more portions of the light valve layer in contact with the LGP surface may be used and is intended to fall within the scope of the disclosure.

In certain embodiments, the light source 325 may be a polychromatic coherent light source configured to inject light of mixed polarization (“A/B”) into the LGP 305. In such instances, the first region(s) 311′ may be configured or activated to allow light of polarization A to pass through, whereas the second region(s) 312 may be configured or activated to allow light of polarization B to pass through, or vice versa without limitation. Moreover, it may also be possible, in some embodiments, to alter the polarization state of the injected light as appropriate to achieve a desired light output, for example, changing the polarization of the injected light from A to B, or vice versa without limitation. Furthermore, while polarized light may be injected in one polarization state, such a polarization state can be phase shifted due to TIR to yield an “effective” polarization. This phase shift may be taken into account when configuring the polarization of the light valve layer portion(s) in the active and/or inactive states.

FIGS. 4A-B illustrate a further exemplary embodiment of a BLU in inactive (400) and active (400′) states, respectively. Similar to FIGS. 3A-B, a light guide assembly 410 can comprise an LGP 405 and a light valve layer 415 in physical contact with a surface of the LGP 405. A light source 425 can be optically coupled to the LGP 405 to introduce light L to the LGP, e.g., to at least one edge 401 of the LGP 405.

As illustrated, the light valve layer 415 can comprise a material having a first refractive index (“n1”) in contact with a light-emitting surface 402 of the LGP 405. The refractive index n1 of valve layer 415 may, in some embodiments, be different than a second refractive index (“n2”) of the LGP 405, such as higher or lower than refractive index n2. In some embodiments, in an inactive state, the first refractive index n1 may be at least about 5% higher or lower than the second refractive index n2, such as ranging from about 5% to about 50%, from about 10% to about 40%, from about 15% to about 30%, or from about 20% to about 25% higher or lower than n2, including all ranges and subranges therebetween. In an active state, the first refractive index n1 may be within about 5% of the second refractive index n2, such as ranging from about 0.5% to about 5%, from about 1% to about 4%, or from about 2% to about 3% higher or lower than n2, including all ranges and subranges therebetween. In some embodiments, the first refractive index n1 may be different from the second refractive index n2 in an inactive state and substantially equal to the second refractive index n2 in an active state. Non-limiting examples of suitable materials for the light valve layer 415 may include, for instance, porous materials which may change refractive index upon compression and/or expansion, and other similar gas/liquid or solid/liquid heterogeneous systems.

Upon application of an electronic signal or electric field, e.g., by a switch mechanism (not shown), at least a portion of the light valve layer 415 can be activated to change the refractive index of the layer. In this active state, as demonstrated by activated portion 415′, TIR may be reduced (e.g., TIR<10%) for injected light incident upon the light-emitting surface 402 of first region 411′ due to a change to the interfacial conditions in this region (e.g., a change in the n1 value), such that light RL propagating through the LGP is transmitted by the light-emitting surface 402 as transmitted light TL from the first region 411′. For instance, a change in refractive index n1 may increase the critical angle (Θ_{c}) at the light-emitting surface such that about 90% or greater of light incident on the light-emitting surface may have an incident angle (Θ₁) less than the critical angle (Θ_{c}). In contrast, second regions 412, which are not activated, will have the same interfacial conditions (e.g., the same n1 value) and will not, or will not substantially, transmit light. Accordingly, in some embodiments, when viewed by a user, a portion of a display corresponding to first region(s) 411′ may appear illuminated whereas a portion of the display corresponding to the second region(s) 412 may appear dark.

While FIG. 4B illustrates only one activated portion 415′, it is to be understood that more than one portion of the light valve layer 415 may be activated as appropriate to produce a desired light output. Furthermore, it is also possible for the activated portion(s) 415′ to be separately controllable, e.g., a first region (e.g., 411′) may have active/inactive light valve portions and a second region (e.g., 412) may have active/inactive light valve portions. Finally, it is to be understood that the illustrated embodiment in FIGS. 4A-B is exemplary only and is not intended to be limiting on the appended claims. Any suitable arrangement for altering one or more portions of the light valve layer in contact with the LGP surface may be used and is intended to fall within the scope of the disclosure.

In various embodiments, light valve layer 415 may also be used to alter and/or control frustrated TIR (FTIR) within the BLU 400. For example, an additional layer (not illustrated) may be placed on top of the light valve layer 415, such that valve layer 415 is sandwiched between the LGP 405 and the additional layer. In such a configuration, the LGP 405 and additional layer may both be chosen to have refractive indices n2 and n3, respectively, which are greater than the refractive index n1 of the light valve layer 415. One or more portions of the light valve layer 415 may then be switched from an inactive to an active state to increase the refractive index n1 of the valve layer so as to frustrate TIR within the LGP 405 and allow for the transmission of light through the light valve layer 415. Alternatively, the additional layer may be separated from the LGP by an electrowettable material, such as fluoropolymers, such that the thickness of the gap between the additional layer and LGP can be controlled. TIR within the LGP can then be frustrated by decreasing the gap between the additional layer and the LGP such that they are sufficiently close for transmission of light between the two layers.

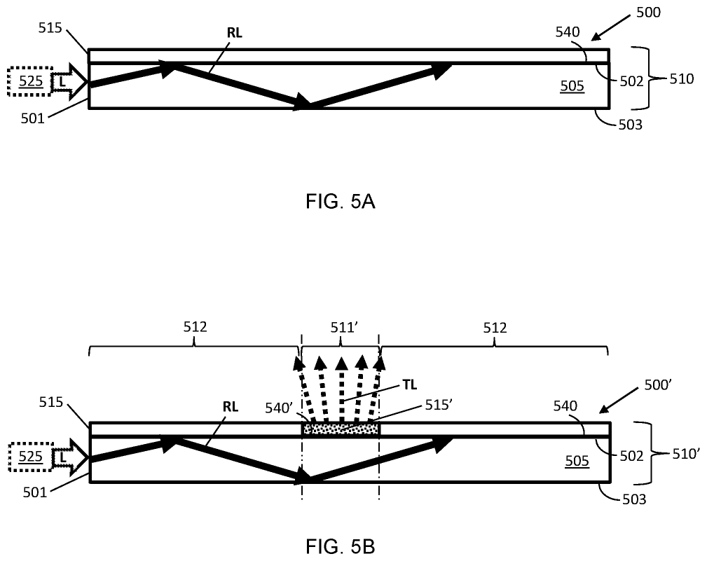

FIGS. 5A-B illustrate yet another exemplary embodiment of a BLU in inactive (500) and active (500′) states, respectively. Similar to FIGS. 3A-B, a light guide assembly 510 can comprise an LGP 505 and a light valve layer 515 in physical contact with a surface of the LGP 505. A light source 525 can be optically coupled to the LGP 505 to introduce light L to the LGP, e.g., to at least one edge 501 of the LGP 505.

As illustrated in FIG. 5A, the light valve layer 515 can comprise a material having a first texture (e.g., surface smoothness or roughness and/or porosity) in contact with a light-emitting surface 502 of the LGP 505. In some embodiments, in an inactive state, the light valve layer 515 may have a non-porous microstructure and/or a substantially smooth surface 540 in contact with light-emitting surface 502 of the LGP 505, e.g., the light valve layer 515 may be substantially free of light-scattering sites in an inactive state. In an active state, as illustrated in FIG. 5B, an activated portion 515′ of the light valve layer may have a surface 540′ in contact with light-emitting surface 502, which is roughened and/or a microstructure that is porous, e.g., a portion of the light valve layer may comprise light-scattering sites in an active state. Non-limiting examples of suitable materials for the light valve layer 515 may include, for instance, materials which can change porosity and/or surface roughness upon compression and/or expansion.

Upon application of an electronic signal or electric field, e.g., by a switch mechanism (not shown), at least a portion of the light valve layer 515 can be activated to change the texture of the layer such that the activated portion scatters light from the LGP. In this active state, as demonstrated by activated portion 515′, TIR may be reduced (e.g., TIR<10%) for light incident upon the light-emitting surface 502 of first region 511′, such that light RL propagating through the LGP is scattered forward from the light-emitting surface 502 and is transmitted by the first region 511′ as transmitted light TL. In contrast, second regions 512, which are not activated, will not, or will not substantially, scatter light forward. Accordingly, in some embodiments, when viewed by a user, a portion of a display corresponding to first region(s) 511′ may appear illuminated whereas a portion of the display corresponding to the second region(s) 512 may appear dark.

While FIG. 5B illustrates only one activated portion 515′, it is to be understood that more than one portion of the light valve layer 515 may be activated as appropriate to produce a desired light output. Furthermore, it is also possible for the activated portion(s) 515′ to be separately controllable, e.g., a first region (e.g., 511′) may have active/inactive light valve portions and a second region (e.g., 512) may have active/inactive light valve portions. Finally, it is to be understood that the illustrated embodiment in FIGS. 5A-B is exemplary only and is not intended to be limiting on the appended claims. Any suitable arrangement for altering one or more portions of the light valve layer in contact with the LGP surface may be used and is intended to fall within the scope of the disclosure.

According to various embodiments, referring to any one of FIGS. 1-5, the light-emitting surface 102 (202, 302, 402, 502) or rear panel-facing surface 103 (203, 303, 403, 503) of the LGP 105 (205, 305, 405, 505) may be patterned with a plurality of light extraction features. As used herein, the term “patterned” is intended to denote that the plurality of light extraction features is present on or in the surface of the light guide plate in any given pattern or design, which may, for example, be random or arranged, repetitive or non-repetitive, uniform or non-uniform. In other embodiments, the light extraction features may be located within the matrix of the LGP adjacent the surface, e.g., below the surface. For instance, the light extraction features may be distributed across the surface, e.g. as textural features making up a roughened or raised surface, or may be distributed within and throughout the LGP or portions thereof, e.g., as laser-damaged features. Suitable methods for creating such light extraction features can include printing, such as inkjet printing, screen printing, microprinting, and the like, texturing, mechanical roughening, etching, injection molding, coating, laser damaging, or any combination thereof. Non-limiting examples of such methods include, for instance, acid etching a surface, coating a surface with TiO₂, and laser damaging the LGP by focusing a laser on a surface or within the matrix of the LGP. Light extraction features may be produced using the methods disclosed in co-pending and co-owned International Patent Application Nos. PCT/US2013/063622 and PCT/US2014/070771, each incorporated herein by reference in their entirety.

In various embodiments, the light extraction features optionally present on the light-emitting or rear panel-facing surface of the LGP may comprise light scattering sites. According to various embodiments, the extraction features may be patterned in a suitable density so as to produce substantially uniform light output intensity across the light-emitting surface of the LGP. In other embodiments, the light extraction features may be patterned to produce non-uniform light output intensity across the light-emitting surface of the LGP. In certain embodiments, a density of the light extraction features proximate the light source may be greater than a density of the light extraction features at a point further removed from the light source, or vice versa, such as a gradient from one end to another, as appropriate to create the desired light output distribution across the LGP or overall device.

The light extraction features may produce surface scattering and/or volumetric scattering of light, depending on the depth of the features in the LGP surface. The sizes of the light extraction features may also affect the light scattering properties of the LGP. Without wishing to be bound by theory, it is believed that small features may scatter light backwards as well as forwards, whereas larger features tend to scatter light predominantly forward. Thus, for example, according to various embodiments, the light extraction features may have a correlation length less than about 100 nm, such as 70 nm, or less than about 50 nm. Furthermore, larger extraction features may, in some embodiments, provide a forward light scatter but at a small angular spread. Accordingly, in various embodiments, the light extraction features may range in correlation length from about 20 nm to about 500 nm, such as from about 50 nm to about 100 nm, from about 150 nm to about 200 nm, or from about 250 to about 350 nm, including all ranges and subranges therebetween, as well as combinations of ranges to form hierarchical features. The optical characteristics of the light extraction features can be controlled, e.g., by the processing parameters used when producing the extraction features.

In certain embodiments, the light-emitting or rear panel-facing surface of the LGP may have a texture produced, for instance, by etching, damaging, coating, and/or roughening, such that the surface has an average roughness Rₐ ranging from about 10 nm to about 150 nm, such as less than about 100 nm, less than about 80 nm, less than about 60 nm, less than about 50 nm, or less than about 25 nm, including all ranges and subranges therebetween. For example, one or more surfaces of the LGP may have a surface roughness Rₐ of about 50 nm or, in other embodiments, about 100 nm, or about 20 nm.

Referring again to any one of FIGS. 1-5, light-emitting surface 102 (202, 302, 402, 502) or rear panel-facing surface 103 (203, 303, 403, 503) may, in certain embodiments, be planar or substantially planar, e.g., substantially flat and/or level. The surfaces may, in various embodiments, be parallel or substantially parallel. The LGP 105 (205, 305, 405, 505) may comprise four edges or may comprise more than four edges, e.g., a multi-sided polygon. In other embodiments, the LGP may comprise less than four edges, e.g., a triangle, circle, or oval. By way of a non-limiting example, the LGP may comprise a rectangular, square, or rhomboid sheet having four edges, although other shapes and configurations are intended to fall within the scope of the disclosure including those having one or more curvilinear portions or edges.

The LGP can comprise any material known in the art for use in display devices. For example, the LGP can comprise plastics, such as polymethylmethacrylate (PMMA), micros-structured (MS) materials, or glasses, to name a few. Exemplary glasses can include, but are not limited to, aluminosilicate, alkali-aluminosilicate, borosilicate, alkali-borosilicate, aluminoborosilicate, alkali-alum inoborosilicate, soda lime, and other suitable glasses. Non-limiting examples of commercially available glasses suitable for use as a glass light guide include, for instance, EAGLE XG®, Lotus™, Willow®, Iris™, and Gorilla® glasses from Corning Incorporated. In yet further embodiments, the LGP can comprise a composite LGP including both glass and plastic, thus, any specific embodiments described herein with reference to only glass LGPs should not limit the scope of the claims appended herewith.

Some non-limiting glass compositions can include between about 50 mol % to about 90 mol % SiO₂, between 0 mol % to about 20 mol % Al₂O₃, between 0 mol % to about 20 mol % B₂O₃, and between 0 mol % to about 25 mol % RₓO, wherein R is any one or more of Li, Na, K, Rb, Cs and x is 2, or Zn, Mg, Ca, Sr or Ba and x is 1, and wherein the glass produces less than or equal to 2 dB/500 mm absorption. In some embodiments, the glass comprises less than 1 ppm each of Co, Ni, and Cr. In some embodiments, the concentration of Fe is <about 50 ppm, <about 20 ppm, or <about 10 ppm. In other embodiments, Fe +30Cr+35Ni<about 60 ppm, Fe+30Cr+35Ni<about 40 ppm, Fe+30Cr+35Ni<about 20 ppm, or Fe+30Cr+35Ni<about 10 ppm. In other embodiments, the composition comprises between about 60 mol % to about 80 mol % SiO₂, between about 0.1 mol % to about 15 mol % Al₂O₃, 0 mol % to about 12 mol % B₂O₃, and about 0.1 mol % to about 15 mol % R₂O and about 0.1 mol % to about 15 mol % RO, wherein R is any one or more of Li, Na, K, Rb, Cs and x is 2, or Zn, Mg, Ca, Sr or Ba and x is 1, and wherein the glass produces less than or equal to 2 dB/500 mm absorption. In some embodiments, the glass produces a color shift less than 0.006, less than 0.005, less than 0.004, or less than 0.003.

In other embodiments, the glass composition can comprise between about 65.79 mol % to about 78.17 mol % SiO₂, between about 2.94 mol % to about 12.12 mol % Al₂O₃, between about 0 mol % to about 11.16 mol % B₂O₃, between about 0 mol % to about 2.06 mol % Li₂O, between about 3.52 mol % to about 13.25 mol % Na₂O, between about 0 mol % to about 4.83 mol % K₂O, between about 0 mol % to about 3.01 mol % ZnO, between about 0 mol % to about 8.72 mol % MgO, between about 0 mol % to about 4.24 mol % CaO, between about 0 mol % to about 6.17 mol % SrO, between about 0 mol % to about 4.3 mol % BaO, and between about 0.07 mol % to about 0.11 mol % SnO₂. In some embodiments, the glass can produce a color shift<0.015. In some embodiments, the glass can produce a color shift<0.008, less than 0.005, or less than 0.003.

In additional embodiments, the glass composition can comprise an RₓO/Al₂O₃ ratio between 0.95 and 3.23, wherein R is any one or more of Li, Na, K, Rb, Cs and x is 2. In further embodiments, the glass composition may comprise an RₓO/Al₂O₃ ratio between 1.18 and 5.68, wherein R is any one or more of Li, Na, K, Rb, Cs and x is 2, or Zn, Mg, Ca, Sr or Ba and x is 1. In yet further embodiments, the glass composition can comprise an RₓO—Al₂O₃—MgO between −4.25 and 4.0, wherein R is any one or more of Li, Na, K, Rb, Cs and x is 2. In still further embodiments, the glass composition may comprise between about 66 mol % to about 78 mol % SiO₂, between about 4 mol % to about 11 mol % Al₂O₃, between about 4 mol % to about 11 mol % B₂O₃, between about 0 mol % to about 2 mol % Li₂O, between about 4 mol % to about 12 mol % Na₂O, between about 0 mol % to about 2 mol % K₂O, between about 0 mol % to about 2 mol % ZnO, between about 0 mol % to about 5 mol % MgO, between about 0 mol % to about 2 mol % CaO, between about 0 mol % to about 5 mol % SrO, between about 0 mol % to about 2 mol % BaO, and between about 0 mol % to about 2 mol % SnO₂.

In additional embodiments, the glass composition can comprise between about 72 mol % to about 80 mol % SiO₂, between about 3 mol % to about 7 mol % Al₂O₃, between about 0 mol % to about 2 mol % B₂O₃, between about 0 mol % to about 2 mol % Li₂O, between about 6 mol % to about 15 mol % Na₂O, between about 0 mol % to about 2 mol % K₂O, between about 0 mol % to about 2 mol % ZnO, between about 2 mol % to about 10 mol % MgO, between about 0 mol % to about 2 mol % CaO, between about 0 mol % to about 2 mol % SrO, between about 0 mol % to about 2 mol % BaO, and between about 0 mol % to about 2 mol % SnO₂. In certain embodiments, the glass composition can comprise between about 60 mol % to about 80 mol % SiO₂, between about 0 mol % to about 15 mol % Al₂O₃, between about 0 mol % to about 15 mol % B₂O₃, and about 2 mol % to about 50 mol % RₓO, wherein R is any one or more of Li, Na, K, Rb, Cs and x is 2, or Zn, Mg, Ca, Sr or Ba and x is 1, and wherein Fe+30Cr+35Ni<about 60 ppm.

The LGP may comprise a glass that has been chemically strengthened, e.g., by ion exchange. During the ion exchange process, ions within a glass sheet at or near the surface of the glass sheet may be exchanged for larger metal ions, for example, from a salt bath. The incorporation of the larger ions into the glass can strengthen the sheet by creating a compressive stress in a near surface region. A corresponding tensile stress can be induced within a central region of the glass sheet to balance the compressive stress.

Ion exchange may be carried out, for example, by immersing the glass in a molten salt bath for a predetermined period of time. Exemplary salt baths include, but are not limited to, KNO₃, LiNO₃, NaNO₃, RbNO₃, and combinations thereof. The temperature of the molten salt bath and treatment time period can vary. It is within the ability of one skilled in the art to determine the time and temperature according to the desired application. By way of a non-limiting example, the temperature of the molten salt bath may range from about 400° C. to about 800° C., such as from about 400° C. to about 500° C., and the predetermined time period may range from about 4 to about 24 hours, such as from about 4 hours to about 10 hours, although other temperature and time combinations are envisioned. By way of a non-limiting example, the glass can be submerged in a KNO3 bath, for example, at about 450° C. for about 6 hours to obtain a K-enriched layer which imparts a surface compressive stress.

The LGP and/or the entire light guide assembly can, in certain embodiments be transparent or substantially transparent. As used herein, the term “transparent” is intended to denote that the LGP (or assembly) has a transmission of greater than about 80% in the visible region of the spectrum (400-700 nm). For instance, an exemplary transparent LGP may have greater than about 85% transmittance in the visible light range, such as greater than about 90%, greater than about 95%, or greater than about 97% transmittance, including all ranges and subranges therebetween. In certain embodiments, an exemplary LGP (or assembly) may have a transmittance of greater than about 50% in the ultraviolet (UV) region (100-400 nm), such as greater than about 55%, greater than about 60%, greater than about 65%, greater than about 70%, greater than about 75%, greater than about 80%, greater than about 85%, greater than about 90%, greater than about 95%, or greater than about 99% transmittance, including all ranges and subranges therebetween.

In some embodiments, an exemplary transparent LGP can comprise less than 1 ppm each of Co, Ni, and Cr. In some embodiments, the concentration of Fe is <about 50 ppm, <about 20 ppm, or <about 10 ppm. In other embodiments, Fe+30Cr+35Ni<about 60 ppm, Fe+30Cr+35Ni<about 40 ppm, Fe+30Cr+35Ni<about 20 ppm, or Fe+30Cr+35Ni<about 10 ppm. According to additional embodiments, an exemplary transparent LGP can comprise a color shift<0.015 or, in some embodiments, a color shift<0.008. The optical light scattering characteristics of the LGP may also be affected by the refractive index of the LGP material. According to various embodiments, the LGP may have a refractive index ranging from about 1.3 to about 1.8, such as from about 1.35 to about 1.7, from about 1.4 to about 1.65, from about 1.45 to about 1.6, or from about 1.5 to about 1.55, including all ranges and subranges therebetween.

The LGP can have any desired size and/or shape as appropriate to produce a desired light distribution. In certain embodiments, the LGP may have a thickness extending between the light-transmitting surface and the rear panel-facing surface of less than or equal to about 3 mm, for example, ranging from about 0.1 mm to about 2.5 mm, from about 0.3 mm to about 2 mm, from about 0.5 mm to about 1.5 mm, or from about 0.7 mm to about 1 mm, including all ranges and subranges therebetween. In some embodiments, the LGP may have a square shape with any desired dimensions, such as 1 mm×1 mm, 5 mm×5 mm, 10 mm×10 mm, 50 mm×50 mm, 100 mm×100 mm, 200 mm×200 mm, 300 mm×300 mm, 400 mm×400 mm, 500 mm×500 mm, 600 mm×600 mm, 700 mm×700 mm, 800 mm×800 mm, 900 mm×900 mm, 1 m×1 m, 2 m×2 m, 3 m×3 m, 4 m×4 m, 5 m×5 m, 6 m×6 m, 7 m×7 m, 8 m×8 m, 9 m×9 m, 10 m×10 m, and so on. Of course the LGP may also have any other shape (e.g., rectangular, rhomboid, triangular, circular, etc.) and the dimensions above may correspond to one or more dimensions of these shapes (e.g., width, length, height, diameter, etc.). In some embodiments, the LGP may have at least one dimension (e.g. length and/or width, etc.) ranging from about 1 mm to about 1 m, such as from about 5mm to about 500 mm, from about 10 mm to about 300 mm, from about 25 mm to about 200 mm, or from about 50 mm to about 100 mm, including all ranges and subranges therebetween.

Also disclosed herein are LGPs comprising a plurality of tiles arranged to form a two-dimensional LGP array, as opposed to the monolithic structures depicted in FIGS. 1-5. A BLU utilizing such an array can, in some embodiments, provide improved local dimming and/or contrast as compared to a BLU utilizing a monolithic LGP due to the ability to individually address multiple tiles in the array. For example, as discussed above, each tile can correspond to a first or second (or third, fourth, fifth, or more) region of the LGP and can be switched on and off using any of the mechanisms disclosed herein. Moreover, each tile can be supplied with a discrete light valve layer that can be switched on and off without affecting the light valve layer(s) on adjacent tile(s) and/or different light valve layers can be applied to different tiles. Additionally, the ability to arrange multiple tiles together to create an LGP can provide greater flexibility in preparing lighting devices for multiple applications with different size specifications, for instance, for small lighting applications (e.g., from 1-10 mm), mobile and handheld applications (e.g., from 10 mm- 20 cm), display applications (e.g., from 10 cm- 200 cm), and billboards (e.g., from 1 m- 10 m). In certain embodiments, an LGP comprising a tiled array can have at least one dimension (e.g., length, width, height, diameter, etc.) ranging from about 50 mm to about 10 m.

According to various aspects of the disclosure, BLUs can comprise at least one of the disclosed LGPs coupled to at least one light source, which may emit blue light such as UV light (approximately 100-400 nm) or near-UV light (approximately 300-400 nm). In some embodiments, the light source may be a light-emitting diode (LED). According to various embodiments disclosed herein, the pulse width of the light source(s) may be modulated to provide regions of varying brightness in the display. For example, the pulse width of the light source, such as an LED, may range from about 1 ms to about 10 s, such as from about 2 ms to about 5 s, from about 3 ms to about 2 s, from about 4 ms to about 1 s, from about 5 ms to about 0.8 s, from about 6 ms to about 0.6 s, from about 7 ms to about 0.5 s, from about 8 ms to about 0.3 s, from about 9 ms to about 0.2 s, from about 10 ms to about 0.1 s, from about 15 ms to about 50 ms, or from about 20 ms to about 30 ms, including all ranges and subranges therebetween. In some embodiments, two or more light sources may be coupled to one or more edges of the LGP and may be modulated to have different pulse widths, as discussed in more detail below. Modulation of the light source pulse width(s) may be used in combination with any of the light valve mechanisms disclosed herein to provide a variety of bright/dark display regions.

The BLUs disclosed herein may be used in various display devices including, but not limited to LCDs. The optical components of an exemplary LCD may further comprise a reflector, a diffuser, one or more prism films, one or more linear or reflecting polarizers, a thin film transistor (TFT) array, a liquid crystal layer, and one or more color filters, to name a few components.

### Methods

Also disclosed herein are methods for displaying an image, the methods comprising introducing light into a light guide assembly disclosed herein, and switching a first region of the light guide assembly between an active state and an inactive state. The LGP and light valve layer components utilized in the methods disclosed herein can be the same as those described above with respect to the BLUs. Similarly, the mechanisms for switching portions of the light valve layer from active to inactive states may be the same, e.g., application of electronic or electro-mechanical signals (MEMS) using a control unit or electrical system, application of an electric field using electrodes, and the like. According to various embodiments, switching times between active and inactive states may vary depending on the switch mechanism utilized. For instance, the switch time may range from about 1 ms to about 10 s, such as from about 2 ms to about 5 s, from about 3 ms to about 2 s, from about 4 ms to about 1 s, from about 5 ms to about 0.8 s, from about 6 ms to about 0.6 s, from about 7 ms to about 0.5 s, from about 8 ms to about 0.3 s, from about 9 ms to about 0.2 s, from about 10 ms to about 0.1 s, from about 15 ms to about 50 ms, or from about 20 ms to about 30 ms, including all ranges and subranges therebetween.

Further disclosed herein are methods for displaying an image, the methods comprising optically coupling a plurality of light sources to at least one edge of a light guide plate comprising a reverse prism film on a light-emitting surface, and modulating the pulse width of at least two light sources in the plurality of light sources to produce a first display region with a first light transmission greater than a second light transmission of a second display region.

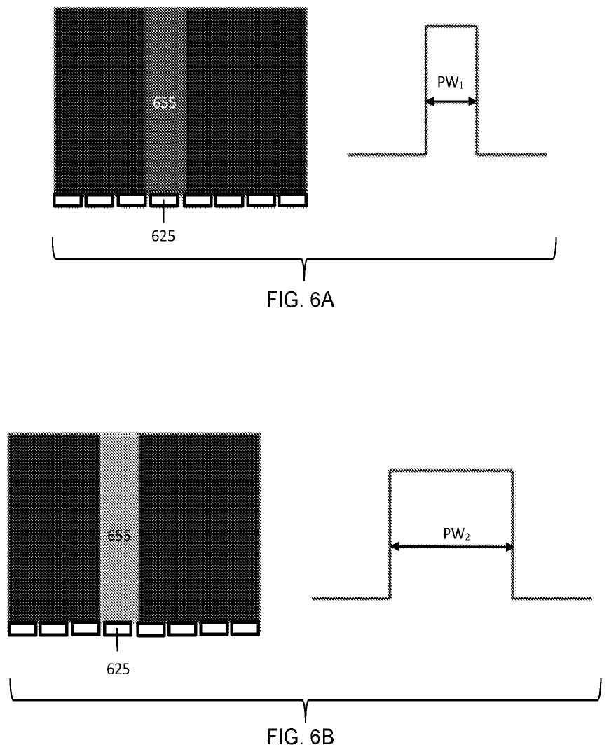

FIGS. 6A-B illustrate light sources 625 operated at varying pulse widths PW₁ and PW₂, respectively. These figures demonstrate, among other things, that a change in pulse width does not change the specific area of the LGP illuminated by the light source. Rather, a longer pulse width PW₂ may result in brighter illumination of the region 655 lit by light source 625, as compared to a shorter pulse width PW₁ (compare, e.g., FIG. 6B to FIG. 6A). Moreover, FIGS. 6A-B are simplified representations of light distribution in the LGP, as light leakage and reflection within the LGP can result in illumination of regions other than the “rows” or “columns” of the LGP aligned with a particular light source 625. Thus, it may not be possible to light specific regions of the BLU only by modulating the pulse width of the light source(s).

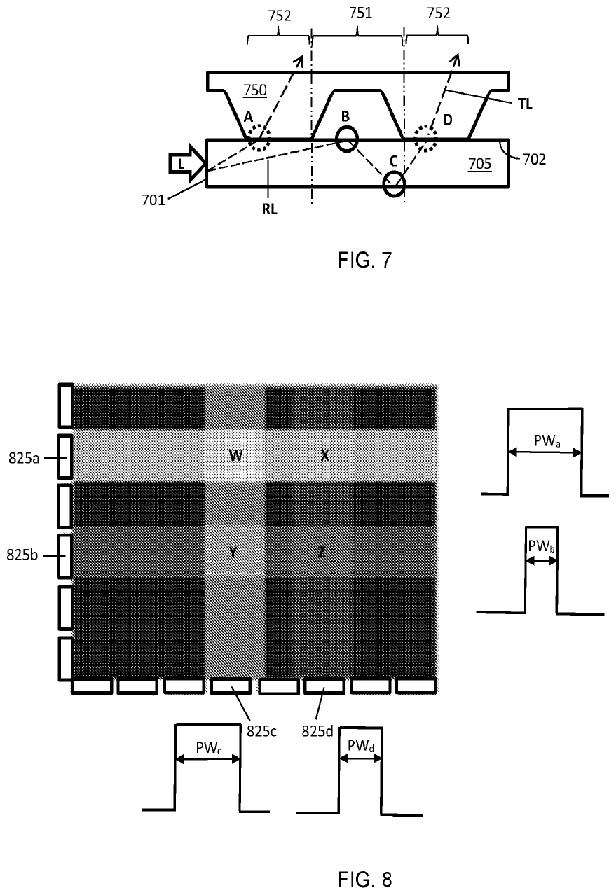

FIG. 7 illustrates an exemplary LGP 705 with a reverse prism film 750 disposed on a light-emitting surface 702. Light L introduced at an edge 701 of the light plate may reflect within the LGP as reflected light RL. For example, light L striking the LGP-air boundary at incident angles below the critical angle Θ_{c}, e.g., at points B and C, will reflect off the surface and propagate through the LGP. Light L may also strike the LGP-prism boundary, e.g., at points A and D, and regardless of the incident angle, may be transmitted through the prism 750 as transmitted light TL. As such, the reverse prism film may provide bright region(s) 652 with relatively high light transmission and dark region(s) 651 with relatively low light transmission.

A combination of a reverse prism film with pulse width modulation in a two-dimensional array of light sources may thus make it possible to more brightly light specific regions of the BLU, as shown in FIG. 8. For instance, light source 825a may have a pulse width PWₐ, light source 825b may have a pulse width PW_{b}, light source 825c may have a pulse width PW_{c}, and light source 825d may have a pulse width PW_{d}. These pulse widths may or may not be different from each other, for instance, as illustrated, PWₐ>PW_{c}>PW_{d}>PW_{b}. By changing the pulse widths of different light sources in the array, region(s) of varying brightness W, X, Y, and Z, may be produced. Moreover, a reverse prism film (not shown), can be applied to a light-emitting surface of the LGP and can be designed to limit light transmission in undesired regions, e.g., regions that are to be left dark or relatively dim.

According to various embodiments, e.g., as shown in FIGS. 6A-B, an array of light sources 625 may be optically coupled to a single edge of an LGP. In such a non-limiting configuration, a first light source in the plurality of light sources may be modulated to have a different pulse width than that of a second light source in the plurality of light sources (see, e.g., light sources 825a, 825b or light sources 825c, 825d in FIG. 8). In other embodiments, as illustrated in FIG. 8, a first plurality of light sources may be coupled to one edge of the LGP and a second plurality of light sources may be coupled to an adjacent edge of the LGP. In such a non-limiting configuration, a first light source in the first plurality of light sources may have a first pulse width different from a second light source in the second plurality of light sources (see, e.g., light sources 825a, 825c or light sources 825b, 825d). Exemplary pulse widths for the light source(s) may range from about 1 ms to about 10 s, such as from about 2 ms to about 5 s, from about 3 ms to about 2 s, from about 4 ms to about 1 s, from about 5 ms to about 0.8 s, from about 6 ms to about 0.6 s, from about 7 ms to about 0.5 s, from about 8 ms to about 0.3 s, from about 9 ms to about 0.2 s, from about 10 ms to about 0.1 s, from about 15 ms to about 50 ms, or from about 20 ms to about 30 ms, including all ranges and subranges therebetween, although other pulse widths are possible and may be appropriate to achieve a desired light output.

Of course, the illustrated embodiment in FIG. 8 is exemplary only and is not intended to be limiting on the appended claims. Any suitable arrangement for adjusting the brightness of particular regions of the display may be used and is intended to fall within the scope of the disclosure. Moreover, while FIG. 8 illustrates four particular light sources with four different pulse widths, it is to be understood that the modulated light sources may be in any position along the LGP and that any number of light sources may be modulated as appropriate to produce a desired light output. As such, the display pattern depicted in FIG. 8 with particular regions of brightness/darkness is exemplary only and can be changed by modulating different light sources and/or providing different pulse widths.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a light source” includes examples having two or more such light sources unless the context clearly indicates otherwise. Likewise, a “plurality” or an “array” is intended to denote “more than one.” As such, a “plurality of light sources” includes two or more such light sources, such as three or more such light sources, etc., and an “array of light guide plates” includes two or more such LGPs, such as three or more such LGPs, and so on.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, as defined above, “substantially similar” is intended to denote that two values are equal or approximately equal. In some embodiments, “substantially similar” may denote values within about 5% of each other, such as within about 3% of each other, within about 2% of each other, or within about 1% of each other.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a device that comprises A+B+C include embodiments where a device consists of A+B+C and embodiments where a device consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

1. A backlight unit comprising:
a light guide assembly comprising:
a light guide plate; and
at least one light valve layer; and
at least one light source optically coupled to the light guide plate and configured to inject light into the light guide plate,
wherein the light guide assembly further comprises a first region and a second region, the first region switchable between an active state in which a light-emitting surface of the first region transmits at least about 90% of injected light incident on a corresponding rear panel-facing surface of the first region, and an inactive state in which the light-emitting surface of the first region transmits less than about 10% of injected light incident on the corresponding rear panel-facing surface of the first region.

2. A backlight unit comprising:
a light guide assembly comprising:
a light guide plate; and
at least one light valve layer; and
at least one light source optically coupled to the light guide plate and configured to inject light into the light guide plate,
wherein the light guide assembly further comprises a first region and a second region, the first region switchable between an active state in which at least about 90% of injected light incident on a light-emitting surface is transmitted by the first region, and an inactive state in which less than about 10% of injected light incident on the light-emitting surface is transmitted by the first region.

3. The backlight unit of claim 1 or 2, wherein the at least one light source is optically coupled to one or more edges of the light guide plate.

4. The backlight unit of claim 1 or 2, wherein the second region is configured to switch between an active state and an inactive state.

5. The backlight unit of claim 1 or 2, wherein the light guide assembly comprises a plurality of first regions and optionally a plurality of second regions.

6. The backlight unit of claim 1 or 2, wherein the light guide assembly comprises a plurality of tiles arranged in a two-dimensional array, and wherein one or more tiles correspond to the first region or the second region.

7. The backlight unit of claim 1 or 2, wherein the first region includes at least one dimension ranging from about 1 mm to about 500 m.

8. The backlight unit of claim 1 or 2, wherein the light valve layer is in contact with or adjacent to (a) the light-emitting surface or (b) a rear panel-facing surface of the light guide plate.

9. The backlight unit of claim 1 or 2, further comprising a switch mechanism configured to switch the first region between the active and inactive states within a time period ranging from about 15 microseconds to about 10 seconds.

10. The backlight unit of claim 9, wherein the switch mechanism is configured to induce physical contact between at least a portion of the light valve layer and at least a portion of the light guide plate.

11. The backlight unit of claim 10, wherein, in an active state, the first region comprises a first portion of the light guide plate in physical contact with a first portion of the light valve layer, and, in an inactive state, the first portion of the light guide plate is not in physical contact with the first portion of the light valve layer.

12. The backlight unit of claim 10, wherein the light valve layer comprises a diffusing or light-scattering material.

13. The backlight unit of claim 12, wherein the light valve layer further comprises mechanical components and the switch mechanism comprises an electrical system.

14. The backlight unit of claim 10, wherein the light valve layer comprises at least one of positively charged light-scattering particles or negatively charged light-scattering particles.

15. The backlight unit of claim 14, wherein the switch mechanism comprises two or more electrodes configured to generate an electric field.

16. The backlight unit of claim 9, wherein the switch mechanism is configured to change a filter polarization of at least a portion of the light valve layer.

17. The backlight unit of claim 16, wherein the switch mechanism comprises an electrical system or two or more electrodes configured to generate an electric field.

18. The backlight unit of claim 16, wherein the light source introduces polarized light into the light guide plate.

19. The backlight unit of claim 18, wherein, in an active state, the first region comprises a first portion of the light valve layer having a filter polarization substantially equal to a polarization of the polarized light, and, in an inactive state, the first portion of the light valve layer has a filter polarization different from the polarization of the polarized light.

20. The backlight unit of claim 9, wherein the switch mechanism is configured to change a refractive index of at least a portion of the light valve layer.

21. The backlight unit of claim 9, wherein the switch mechanism is configured to change a roughness or porosity of at least a portion of the light valve layer.

22. The backlight unit of claim 1 or 2, comprising a plurality of light sources optically coupled to at least one edge of the light guide plate.

23. The backlight unit of claim 22, wherein a first light source has a pulse width different from a pulse width of a second light source in the plurality of light sources.

24. The backlight unit of claim 22, wherein a first plurality of light sources is optically coupled to a first edge and a second plurality of light sources is optically coupled to an adjacent second edge.

25. The backlight unit of claim 24, wherein a first light source in the first plurality of light sources has a pulse width different from a pulse width of a second light source in the second plurality of light sources.

26. A display device comprising the backlight unit of claim 1 or 2.

27. A method for displaying an image, comprising:
introducing light into a backlight unit of claim 1 or 2, and
switching the first region of the light guide assembly between an active state and an inactive state.

28. A method for displaying an image, comprising:
optically coupling a plurality of light sources to at least one edge of a light guide plate comprising a reverse prism film on a light-emitting surface, and
modulating the pulse width of at least two light sources in the plurality of light sources to produce a first region with a first light transmission greater than a second light transmission of a second region.

29. The method of claim 28, wherein a first light source has a pulse width different from a pulse width of a second light source in the plurality of light sources.

30. The method of claim 28, wherein a first plurality of light sources is optically coupled to a first edge and a second plurality of light sources is optically coupled to an adjacent second edge.

31. The method of claim 30, wherein a first light source in the first plurality of light sources has a pulse width different from a pulse width of a second light source in the second plurality of light sources.
